(19) United States
(12) Patent Application Publication
(10) Pub. No.: US 2013/0280022 A1
(43) Pub. Date: Oct. 24, 2013

(54) METHOD AND APPARATUS FOR USING AN EXCAVATOR HAVING A BOOM AS A LIFTING APPARATUS

(71) Applicant: Joshua M. Bellavance, Lacombe (CA)

(72) Inventor: Joshua M. Bellavance, Lacombe (CA)

(21) Appl. No.: 13/651,122

(22) Filed: Oct. 12, 2012

(30) Foreign Application Priority Data
Oct. 14, 2011 (CA) 2756182

(51) Int. Cl. B66C 23/62; E02F 3/36

(52) U.S. Cl. CPC B66C 23/62; E02F 3/3609
USPC 414/723; 414/815

(57) ABSTRACT

A method and apparatus for using an excavator having a boom as a lifting apparatus. The apparatus includes a metal plate having a first face and a second face. An excavator bucket quick connect coupling is secured to the first face of the plate, whereby the plate is connected to the boom of the excavator. An arm is provided having a first end and a second end. The first end of the arm is fixed to the second face of the plate and the second end has a coupling for attaching a lifting line.

### FIELD

There is described a method and apparatus for using an excavator having a boom as a lifting apparatus.

### BACKGROUND

Excavators having booms are extremely versatile machines. Although never intended for such use, they are capable of being used as lifting apparatus. When loads being lifted are relatively light, no problems arise. When excessive loads are lifted, a hazard is created that has the potential to topple the excavator. What is required is a method and apparatus that will facilitate safe usage of an excavator having a boom as a lifting apparatus.

### SUMMARY

There is provided an apparatus for using an excavator having a boom as a lifting apparatus. The apparatus includes a metal plate having a first face and a second face. An excavator bucket quick connect coupling is secured to the first face of the plate, whereby the plate is connected to the boom of the excavator. An arm is provided having a first end and a second end. The first end of the arm is fixed to the second face of the plate and the second end has a coupling for attaching a lifting line.

A method is described for using an excavator having a boom as a lifting apparatus. A first step involves providing the apparatus described above. A second step involves securing the apparatus to the boom of the excavator with the quick connect coupling. A third step involves securing a lifting line attached to a load to the coupling at the second end of the arm. A fourth step involves orienting the arm to extend outwardly from the excavator boom. A fifth step involves lifting the boom to raise the load.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is an exploded perspective view of an apparatus for using an excavator having a boom as a lifting apparatus.

FIG. 2 is a side elevation view of the apparatus of FIG. 1 in use lifting a load in accordance with the teachings of the method.

FIG. 3 is a perspective view of an alternative embodiment of the apparatus shown in FIG. 1.

FIG. 4 is an exploded perspective view of the alternative embodiment of the apparatus shown in FIG. 3.

FIG. 5, labelled as PRIOR ART, is a side elevation view of an excavator having a boom being improperly used as a lifting apparatus.

### DETAILED DESCRIPTION

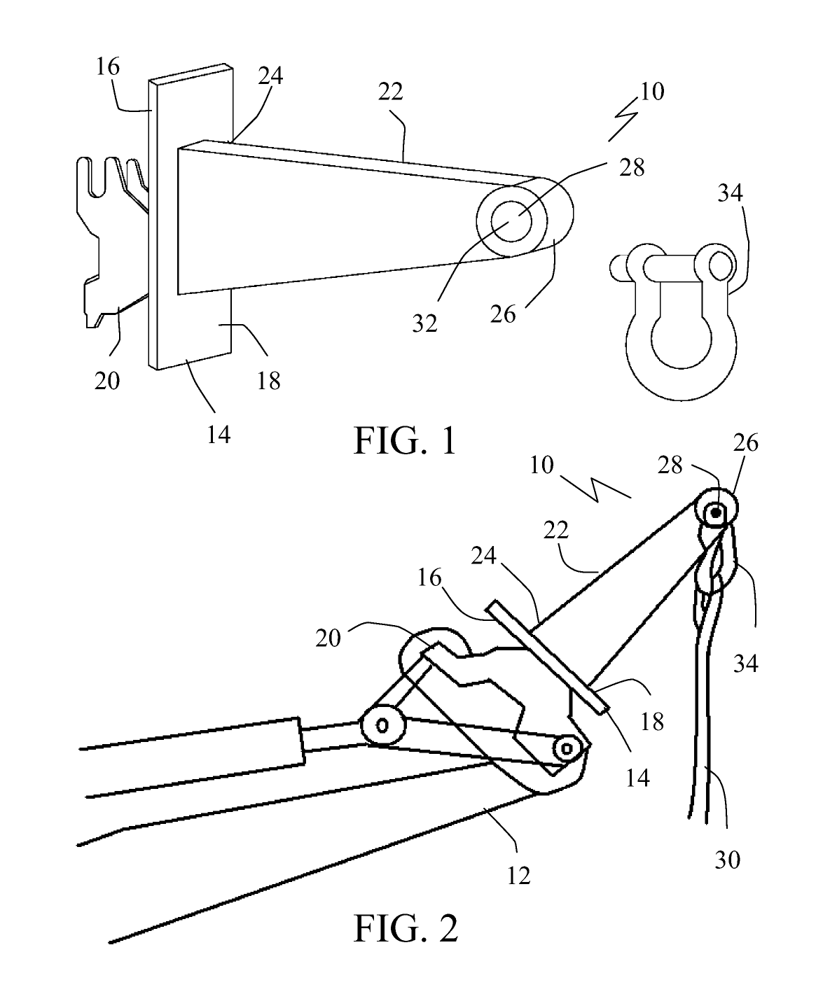

An apparatus for using an excavator having a boom as a lifting apparatus generally identified by reference numeral 10 will now be described with reference to FIGS. 1 through 5.

### Prior Art

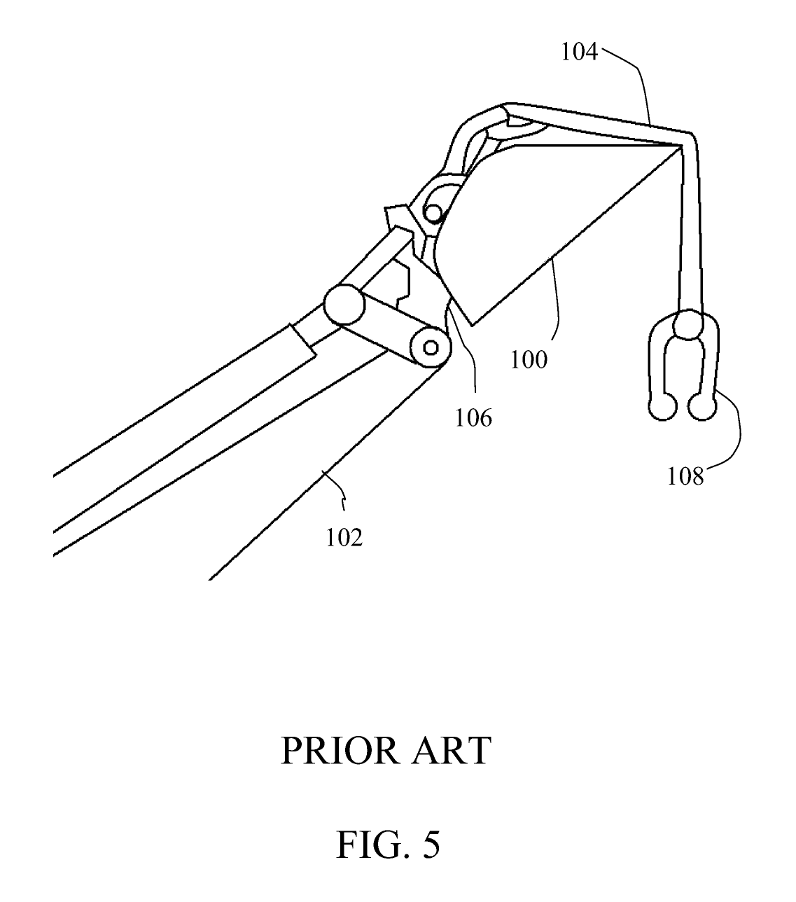

Referring to FIG. 5, excavators, not shown, with booms 102 are often used improperly to lift loads. A bucket 100 is connected to boom 102 by a quick connect 106 and orientated such that bucket 100 is pointed outwardly away from an excavator, not shown. A load 108 is attached by lifting line 104 to bucket 100 and used to raise load. By lifting a load 108 in this way, lifting line 104 may be severed by the bucket. It is also possible that the weight of load 108 may be miscalculated and cause damage to bucket 100, boom 102 or excavator.

### Structure and Relationship of Parts:

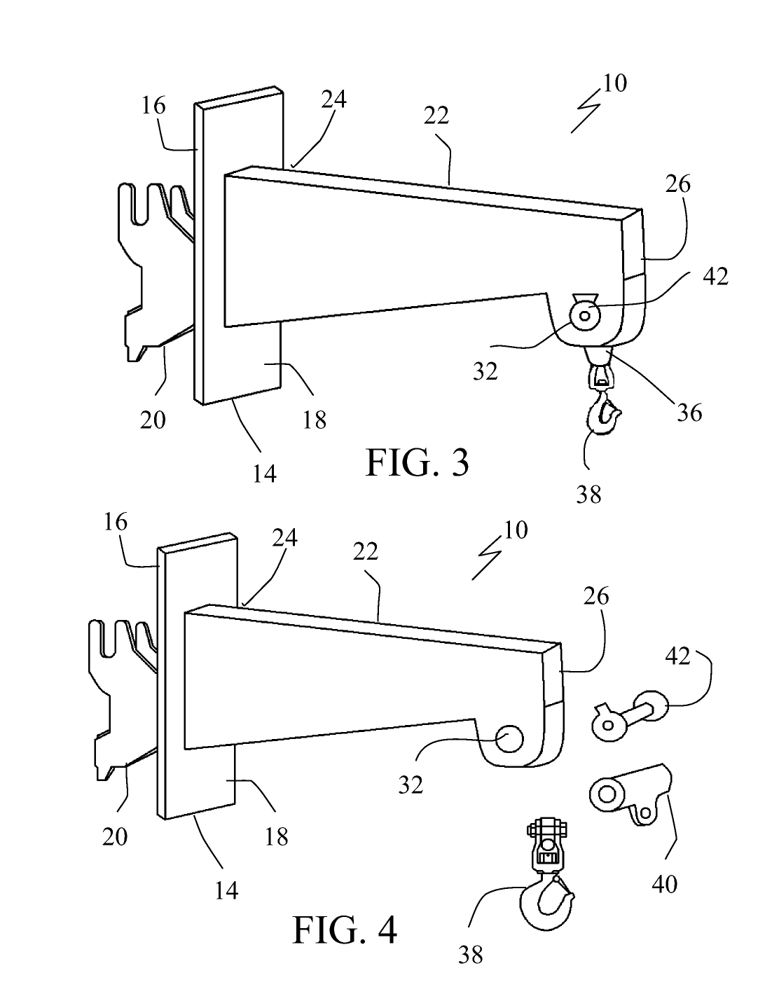

Referring to FIG. 2, an apparatus 10 for using an excavator having a boom 12 as a lifting apparatus has a metal plate 14 that has a first face 16 and a second face 18. An excavator bucket quick connect coupling 20 is secured to first face 16 of plate 14 which connects plate 14 to boom 12 of the excavator, not shown. Referring to FIG. 1, an arm 22 is connected to second face 18 of plate 14. Arm 22 has a first end 24 and a second end 26 with first end 24 being fixed to second face 18 of plate 14. Referring to FIG. 2, second end 26 has a coupling 28 for attaching a lifting line 30. Referring to FIG. 1, in the embodiment shown, coupling 28 is an aperture 32 that extends through second end 26 of arm 22, with aperture 32 receiving a hook shackle 34. Referring to FIG. 3, aperture 32 receives a hook assembly 36. Referring to FIG. 4, hook assembly 36 includes a hook 38, a hook connection 40 and a bar retainer 42. Hook 38 is attached to hook connection 40 and hook connection 40 is attached to second end 26 of arm 22 by bar retainer 42 which passes through aperture 32 and hook connection 40.

### Operation:

Referring to FIG. 2, lifting apparatus 10 is secured to boom 12 of an excavator by quick connect coupling 20. A lifting line 30 attached to a load is secured to coupling 28 at second end 26 of arm 22. Arm 22 is orientated to extend outwardly from excavator boom 12 prior to boom 12 being raised to lift load.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. An apparatus for using an excavator having a boom as a lifting apparatus, comprising:
a metal plate having a first face and a second face;
an excavator bucket quick connect coupling secured to the first face of the plate, whereby the plate is connected to the boom of the excavator; and
an arm having a first end and a second end, the first end being fixed to the second face of the plate, the second end having a coupling for attaching a lifting line.

2. The apparatus of claim 1, wherein the coupling is an aperture extending through the second end of the arm, the aperture receiving a hook shackle.

3. The apparatus of claim 1, wherein the coupling is an aperture extending through the second end of the arm, the aperture receiving a hook assembly.

4. A method for using an excavator having a boom as a lifting apparatus, comprising:
providing an apparatus, comprising:
a metal plate having a first face and a second face;
an excavator bucket quick connect coupling secured to the first face of the plate; and
an arm having a first end and a second end, the first end being fixed to the second face of the plate, the second end having a coupling for attaching a lifting line;
securing the apparatus to the boom of the excavator by connecting the quick connect coupling;
securing a lifting line attached to a load to the coupling at the second end of the arm;
orienting the arm to extend outwardly from the excavator boom; and
lifting the boom to raise the load.
